(19) United States
(12) Patent Application Publication
(10) Pub. No.: US 2003/0011820 A1
(43) Pub. Date: Jan. 16, 2003

(54) Method and device for archiving and transmitting image data

(76) Inventor: Wulf Schmidt-Sacht, Edenwecht (DE)

Correspondence Address: Neil Steinberg, Steinberg & Whitt, Suite 214, 2680 Bayshore Parkway, Mountain View, CA, 94043, US

(21) Appl. No.: 10/129,058

(22) PCT Filed: Jul. 14, 2001
(86) PCT No.: PCT/EP01/08144

(51) Int. Cl. B41B 1/00; G06F 15/00

(52) U.S. Cl. 358/1.16

(57) ABSTRACT

The invention concerns a method of archiving and transmitting image data of a customer to a development laboratory (20), wherein the customer inputs the image data at an input device (1) and there selects at least one image product (15) to be produced by the development laboratory (20) as an order, from which order data are produced by the input device (1). In order in that respect to provide a possible way of archiving image data, it is provided in accordance with the invention that the image data and the order data of the customer after the selection of the at least one image product (15) are stored on a separate data carrier (9) and that on the basis of said data carrier (9) which is transmitted to the development laboratory (20) the at least one selected image product (15) is produced and delivered with the data carrier (9) to the customer. The invention also concerns a corresponding device and a corresponding data carrier for archiving and transmitting image data.

The invention concerns a method of archiving and transmitting image data of a customer to a development laboratory, wherein the customer inputs the image data at an input device and there selects at least one image product to be produced by the development laboratory as an order, from which order data are produced by the input device. The invention further concerns a corresponding device and a corresponding data carrier for archiving and transmitting image data of a customer to a development laboratory.

A method and a device for the input and transmission of image data of a customer to a development laboratory are known from DE 198 40 313 A1. In that case, at an input device which is preferably installed at a photographic store or trader, the customer can input his image data into an input device, in which respect the image data can be stored on different media. Those media can be both of digital nature such as floppy disks, CDs, Smart Media Cards or of analog nature such as film negatives, film positives, or slide transparencies. Those image data are converted at the input device into presentable image data which are presented directly to the customer who in accordance therewith can order one or more image products, for example photographic prints of individual image, a photographic calendar or photographic postcards. The input device thereupon produces order data which, together with the image data, are transmitted for example by way of a telephone network to the development laboratory which produces therefrom the desired image products and supplies them to the customer by way of the photographic store or trader. The data carriers on which the image data of the customer are stored therefore do not have to be sent to the development laboratory to produce the image products.

In the case of the digital photographic cameras which are becoming more and more widespread, image data are stored on storage media such as Smart Media Cards, Compact Flash, PC cards et al, which at the present time are still relatively expensive and which have only a limited storage capacity. It is therefore not appropriate for storage media of that kind to be used as archiving means. For the purposes of reading out the image data, digital photographic cameras can be coupled to a PC in order in that way to store the data for example on the hard drive of the PC, the storage capacity of which however is also limited. Image data from such storage media can also be read in at the known input device, by a procedure whereby either the storage medium is inputted directly or coupling to the digital camera is produced. After the image data are read out of the storage medium, it can then be re-used again, with image data stored thereon then being overwritten.

The object of the present invention, in the known method and the known device, is to provide a possible way of archiving image data. The invention further seeks to provide a suitable data carrier for archiving and transmitting image data.

In terms of the method, that object is attained in that the image data and the order data of the customer are stored after the selection of at least one image product on a separate data carrier and that on the basis of that data carrier which is communicated to the development laboratory the at least one selected image product is produced and delivered with the data carrier to the customer.

In that respect, the invention is based on the idea that the image data and the order data of a customer are not transmitted on-line from the input device to the development laboratory, for example by way of the telephone network, but are stored on a separate data carrier on which only the order data and the image data of that one customer and that one order are stored. In that respect, the data carrier not only stores the image data which are required to produce the image products specified in the order, but preferably stored on the data carrier are all image data which were inputted by the customer at the input device. The data carrier can thus also serve at the same time as an archiving means as more specifically it is delivered together with the result of the order, produced by the development laboratory, that is to say the selected image products, to the customer. The customer can then keep that data carrier as an archiving means while he can erase and re-use his data carriers on which were stored his image data which he inputted into the input device, for example the Smart Media Card of his digital photographic camera, directly after input of the image data into the input device.

In accordance with the invention therefore a data carrier which is individual to the customer is produced, which serves at the same time for communicating the image data from the input device to the development laboratory and to archive all image data of the customer.

Preferably the data carrier used is an optical data carrier, in particular a CD or a DVD. A conventional and known writing device, for example a CD or a DVD burner, can be used in the input device for storage of the image data and the order data on that optical data carrier.

An advantageous development provides that the data carrier can be multiply written, in particular can be used a plurality of times as the data carrier for storage of the image data and the order data, wherein the image data stored in the previous storage processes can be retained or erased. The image data can thus be used a plurality of times for the transmission of image data from the input device to the development laboratory, without losing its purpose as an archiving means, as more and more image data can be stored on the data carrier. A customer can thus bring along his data carrier to the input device in order to store thereon new order data and new image data from other data carriers.

A development of the invention provides that the data carrier is prepared at the input device and has an identification to prevent storage of data on the data carrier by means of unauthorized devices, in particular by means of conventional computers. A customer therefore does not need to bring along his own data carrier to the input device. In order however to prevent improper uses of those data carriers, it is preferably provided that such an improper use is prevented by means of an identification or password on the data carrier. This means that the storage of data can be effected only by means of authorized input devices, while reading-out of data stored on the data carrier is possible everywhere, that is to say even on the customer's own PC, by means of a suitable reading device.

A further embodiment of the invention provides that the input device is designed for the input of image data which occur in different forms, in particular in the form of digital image data stored on a data carrier such as a floppy disk, a Smart Media Card, a Compact Flash, a PC card, a CD, a DVD, a Zip disk or a semiconductor memory, or in the form of analog image data stored as photographic positives, photographic negatives or slide transparencies. The input device is thus prepared for the input of image data stored on all possible data carriers. In addition it can also be easily expanded by further reading devices for future data carriers.

Preferably the input device is arranged to be freely accessible, in particular at a photographic store or trader or in a department store. It is also possible to conceive of other locations such as for example a railroad station waiting room or concourse, a shopping mall or a specialist drugstore.

Alternatively the input device can also be designed for private use, in which case it can also be assembled individually for the individual customers and can only have the reading devices which are necessary for the customer. The device can thus include for example essentially a PC with suitable software, in which case the PC has suitable storage means besides input means or a reading device for the input of image data and data processing means for producing order data.

A further embodiment provides that the image data and/or the order data are transmitted to the development laboratory by way of data remote transmission, in particular by way of the Internet or a telephone line. That can be provided supplemental to transmission of the data carrier to the development laboratory in order to be able to process the order more quickly and to enhance the security of data transmission from the input device to the development laboratory.

A development provides that software for input of the image data into the input device and/or for selection of the at least one image product can be executed on a PC and can be loaded into same from a data carrier or from the Internet. That is especially intended for a preferably simplified input device which is designed for private use so that the customer can also use the invention on his private PC.

It can preferably also be provided that a photographic print can be selected as standard as the order for each image of the inputted image data. This means that as standard a photographic print is produced per image, if the user does not make a selection, or it is possible to offer a particular selection function which permits such a standard selection in a particularly fast and simple manner. In the case of particularly simple input devices it is even possible exclusively to provide such a selection function so that a photographic print is always produced in each case from all inputted image data. In addition however the user could also note in manuscript special requirements for his order, on the packaging, for example the photographic bag with which the data carrier is sent to the development laboratory, for example requests for multiple prints of individual or all images or particular format requests. Such a simple input device can then preferably have only a simple display which indicates to the user what he should do next, either in the form of a text message or as a symbolic representation.

A device which is of a more convenient and luxurious design configuration however has means which permit selection of the at least one image product on the basis of visualization of the image data. In that way all the read-in image data can be displayed simultaneously, group-wise or successively, and the user can select in each case whether and with what special wishes image products are to be produced from the individual images.

In order to prevent the user from reading his image data into the input device and storing same on the data carrier but then not sending the data carrier to the development laboratory but stealing it and keeping it as an archiving means straightaway, it is further provided in accordance with the invention that storage of the image data is effected on the data carrier in encrypted form and/or that the storage procedure is effected incompletely. This means that the user cannot read the image data off the data carrier if the data carrier has not been sent to the development laboratory which decrypts the image data and stores it in encrypted form on the data carrier and/or completes the storage operation.

The storage operation is incompletely implemented when using an optical data carrier in particular in that the lead-out region of the optical data carrier is not written upon storage of the image data and order data in the input device, but only at the development laboratory. It is only thereafter that the image data and order data can be read from the data carrier. Writing of the lead-out region by the user is generally not possible so that, without a written lead-out region, the data carrier is useless to the user. This procedure also has the further advantage that, when transmitting the image data onto the data carrier, a time saving is enjoyed, as writing of the lead-out region onto the optical data carrier, in comparison with transmission of the data carrier, requires a not inconsiderable time which can be between one and two minutes.

A device according to the invention for archiving and transmitting image data is set forth in claim 13. A corresponding data carrier for archiving and transmitting image data is recited in claim 17. Both the device and also the data carrier can be the subject of development or advantageous configurations in identical or similar ways to those described in connection with the method according to the invention and set forth in the claims appended to claim 1.

The invention is described in greater detail hereinafter with reference to the drawings in which:

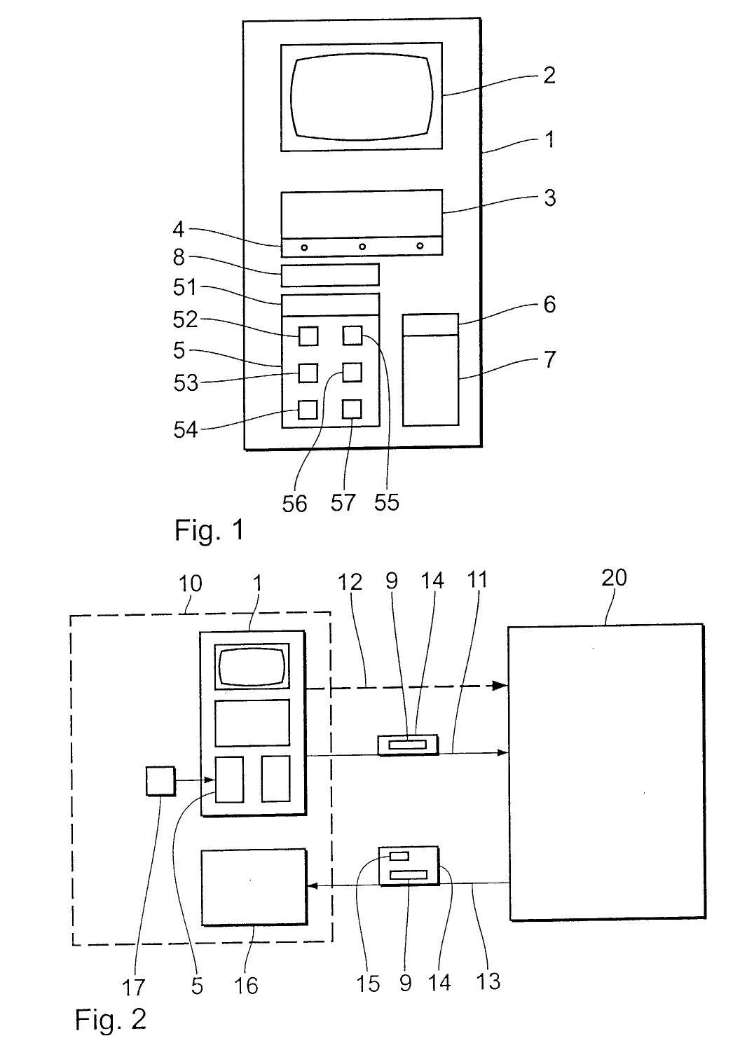

FIG. 1 shows a block circuit diagram of an input device according to the invention,

FIG. 2 shows a block circuit diagram to explain the method according to the invention, and

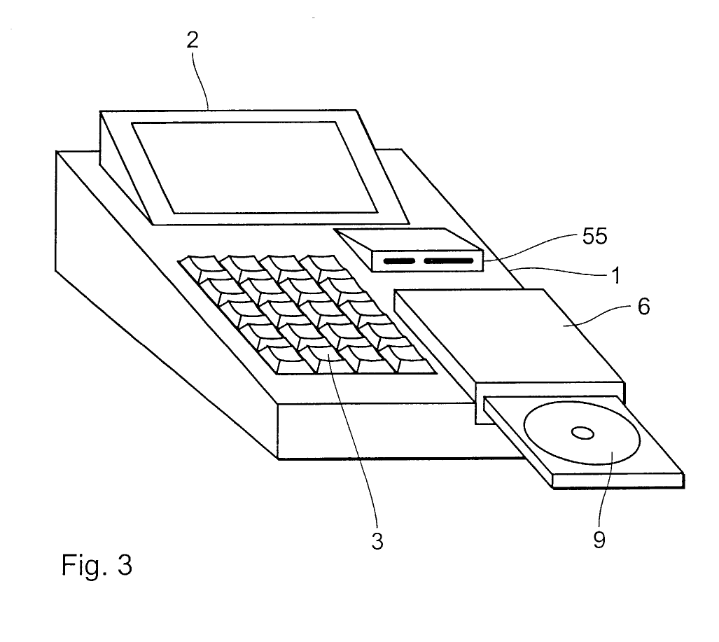

FIG. 3 shows a simplified embodiment of an input device according to the invention.

The input device 1 according to the invention as shown in FIG. 1 has a display 2, for example a conventional monitor or a conventional TV unit, for displaying the inputted image data of a customer and for displaying items of operating and product information. The input device 1 further has selection means 3, 4 which substantially include a keyboard 3 and simple operating knobs 4, with which the customer can input data, for example his address and his name, and can make a selection of image products being offered. For that purpose the display 2 can also be in the form of a touch screen so that the customer can produce inputs or make a selection directly by touching suitable areas.

For the input of image data, there are corresponding input means 5 which are designed for different kinds of image data and for different image data carriers. Shown by way of example here are a scanner 51 for reading in photographic prints, a floppy disk drive 52, a Zip drive 53, a CD drive 54, a reading device 55 for Smart Media Cards, in each case for reading digital image data, as well as a reading device 56 for photographic negatives, a so-called photographic negatives scanner, and a reading device 57 for slide transparencies. A customer can thus bring along one or more data carriers with image data and input same into the input device 1 which converts the image data into corresponding presentable image data which are displayed in succession or simultaneously in the form of miniature images on the display 2. The customer can be guided in that respect by suitable operating menus, which will not be described in greater detail here.

Also provided in the input device 1 is a storage means 6, for example a CD writing device, with a suitable storage holder 7 in which blank and writable CDs are kept in store for the customer. Finally, there are provided data processing means 8 for processing the inputted image data, in particular for conversion into digital presentable image data, and for producing order data corresponding to the selection of image products by the customer.

When now a customer has inputted his image data into the input device 1 and has selected the appropriate image products from his images by means of the selection means 3, 4, all image data inputted by the customer are automatically stored by the input device on one of the data carriers kept in storage, by means of the writing device 6, for which purpose the customer must either take a data carrier out of the storage holder 7 and insert it into the writing device 6, or this takes place automatically. In addition, the data processing means 8 produce order data which are intended for the development laboratory and inform same about the image products selected by the customer, and the corresponding associated image data. They are also stored on the same data carrier as the image data which finally is sent to the development laboratory, for example by means of a collection service operated by the development laboratory. Accordingly, for each individual customer, there is produced a separate data carrier with the image data and the order data thereof, and that data carrier is transmitted to the development laboratory.

The method described will be discussed once again in greater detail with respect to FIG. 2. Therein the input device 1 with the input means 5 is arranged to be freely accessible to customers at a photographic store or trader 10. A customer inputs his image data from one or more image data carriers 17 into the input device 1. From the input device 1 the data carrier with the image data and the order data from the customer passes to the development laboratory 20 by way of the transmission path 11, for example by mail or by means of a collection service. In parallel therewith, the image data and/or the order data can also go to the development laboratory by another way 12, for example over a telephone network or the Internet, in order on the one hand to permit faster processing and on the other hand also to preclude data loss on the data carrier 9 or a complete loss of the data carrier 9.

The result 15 of the order which is produced by the development laboratory, for example the desired photographic prints, are delivered together with the same data carrier 9 and preferably a photo index in a collection bag 14 to the photographic store or trader 10 by way of the transmission path 13, for example by means of the same collection service, by way of which the data carriers 9 also went to the development laboratory 20 from the photographic store or trader 10. There, the customer can collect his collection bag 14 from a collection box 16 and possibly input his data carriers 17 which are freshly written again into the input device 1 in order to order new image products. For that purpose, the customer can then also again use the same image data carrier 9 for storage of the image data inputted into the input device 1 and the order data produced. That can go on until the data carrier 9 no longer has any storage space.

In accordance with the invention therefore the data carrier 9 performs a double purpose, namely for the transmission of image data from the input device 1 to the development laboratory and for archiving of a customer's image data. Writable optical data carriers such as CDs or DVDs which have a very long service life are preferably suitable for that purpose.

FIG. 3 shows a simplified embodiment of an input device 1 according to the invention. This embodiment is in the form of a desktop device and has only the structural groups which are required for the most frequent situations of use. Besides the display screen 2 which can be a simple LCD screen and the selection means 3 which for example can substantially have a combined digit and letter keyboard, these are a reading device 55 for digital storage media such as in particular Smart Media Cards or PC cards and a CD burner 6. Such a desktop device can also be produced at lower cost so that a customer can obtain it at an acceptable price and it can be operated at home. The customer who for example has a digital photographic camera and frequently uses it can thus easily and quickly store his data from the Smart Media Card which he can put into the drive 55, on a CD 9, for archiving purposes. At the same time however he can also operate the device 1 to cause it to display the images he has taken on the display screen 2 and on the basis of those images he can select which image products he wants produced from his image data. The order data produced are then in turn stored on the CD 9 which is the only item which has to be sent to the development laboratory to produce the image products. The CD 9 then comes back directly to the customer together with the image products produced, in the manner described above.

The display screen can also be of a simple design configuration in such a way that it is not the individual images that are displayed thereon, but only indications to the user as to what he has to do as his next step. In the case of such a simple unit, it is then also possible to provide only a standard selection, whereby a photographic print is produced for each individual image. When using such a simple device therefore, the user only has to insert his data carrier with his image data into the input device and insert a data carrier for the overwriting operation. Transfer of the data then takes place automatically. After transfer the user then only has to again remove his data carrier that he brought along and remove the freshly written data carrier and send same to the development laboratory.

Preferably the input device according to the invention is so designed that presentable digital images which are displayed individually in succession on the screen are produced from the image data inputted by a customer, in which respect the customer can decide in relation to each image whether he wants an image product therefrom, or not. By means of suitable key depression, the user can thus also “click” through all images. The input device according to the invention is also so designed, for selecting an image product, that this can be effected as easily as possible. Preferably the selection means provided here are separate keys, with each of which is associated a respective separate function for the selection of a special image product. Overall therefore this is intended to ensure that operation is as easy as possible for the user.

1. A method of archiving and transmitting image data of a customer to a development laboratory (20), wherein the customer inputs the image data at an input device (1) and there selects at least one image product (15) to be produced by the development laboratory (20) as an order, from which order data are produced by the input device (1), characterized in that the image data and the order data of the customer after the selection of the at least one image product (15) are stored on a separate data carrier (9) and that on the basis of said data carrier (9) which is transmitted to the development laboratory (20) the at least one selected image product (15) is produced and delivered with the data carrier (9) to the customer.

2. A method as set forth in claim 1 characterized in that the data carrier (9) used is an optical data carrier, in particular a CD or DVD.

3. A method as set forth in one of the preceding claims characterized in that the data carrier (9) is multiply writable, in particular can be used a multiple of times as a data carrier (9) for storage of the image data and the order data, wherein the image data stored in previous storage operations can be retained or erased.

4. A method as set forth in one of the preceding claims characterized in that the data carrier (9) is prepared at the input device (1) and has an identification for preventing storage of data on the data carrier (9) by means of unauthorized devices, in particular by means of conventional computers.

5. A method as set forth in one of the preceding claims characterized in that the input device (1) is adapted for the input of image data in different forms, in particular in the form of digital image data stored on a data carrier such as a floppy disk, a Smart Media Card, a Compact Flash, a PC card, a CD, a DVD, a Zip disk or a semiconductor memory, or in the form of analog image data stored in the form of photographic positives, photographic negatives or slide transparencies.

6. A method as set forth in one of the preceding claims characterized in that a photographic print can be selected as standard as the order for each image of the inputted image data.

7. A method as set forth in one of the preceding claims characterized in that the selection of the at least one image product (15) is effected on the basis of visualization of the image data at the input device.

8. A method as set forth in one of the preceding claims characterized in that the image data and/or the order data are transmitted to the development laboratory (20) by data remote transmission, in particular by way of the Internet or a telephone line.

9. A method as set forth in one of the preceding claims characterized in that software for input of the image data into the input device (1) and/or selection of the at least one image product (15) can be executed on a PC and can be loaded into same from a data carrier or from the Internet.

10. A method as set forth in one of the preceding claims characterized in that storage of the image data on the data carrier is effected in encrypted form and/or that the storage operation is effected incompletely.

11. A method as set forth in claim 10 characterized in that the lead-out region of the optical data carrier is not written upon storage of the image data and order data in the input device, but only at the development laboratory.

12. A method as set forth in one of the preceding claims characterized in that presentable digital image data which are successively displayed as images are produced from the inputted image data, wherein the customer can make a selection of an image product in relation to each image.

13. A device for archiving and transmitting image data of a customer to a development laboratory (20) comprising input means (5) for the input of image data, selection means (5) for selection of an image product (15) to be produced by the development laboratory (20) to the order of the customer and data processing means (8) for producing order data, characterized in that there are provided storage means (6) for storage of the image data and the order data of the customer after selection of the at least one image product (15) on a separate data carrier (9) intended for transmission to the development laboratory (20), wherein the data carrier (9) is provided for delivery to the customer together with the at least one image product (15).

14. A device as set forth in claim 13 characterized in that the device (1) is in the form of a separate, freely accessible operating terminal which is set up in particular at a photographic store (10) or in a department store (15).

15. A device as set forth in claim 13 characterized in that the device (1) substantially includes a PC with suitable software.

16. A device as set forth in claim 13 characterized in that the device is in the form of a simplified unit with a drive (55) for digital storage media, in particular for Smart Media Cards, as input means, and with a CD or DVD burner (6) as storage means.

17. A data carrier for archiving and transmitting image data of a customer to a development laboratory (20), wherein the stored image data are inputted by a customer at an input device (1) and there at least one image product (15) to be produced by the development laboratory (20) is selected as an order, from which there are produced order data by the input device (1), characterized in that the image data inputted into the input device (1) and the order data of the customer are stored separately on the data carrier (9) after selection of the at least one image product (15) and that the data carrier (9) is provided for transmission to the development laboratory (20) for production of the at least one selected image product and thereafter for delivery to the customer together with the image product (15) produced.

18. A data carrier as set forth in claim 17 characterized in that the data carrier (9) is a writable CD or DVD.
